(19) United States
(12) Patent Application Publication
(10) Pub. No.: US 2008/0246257 A1
(43) Pub. Date: Oct. 9, 2008

(54) AXLE MODULE FOR A VEHICLE

(75) Inventor: Horst KRIMMEL, Tettnang (DE)

Correspondence Address: DAVIS BUJOLD & Daniels, P.L.L.C., 112 PLEASANT STREET, CONCORD, NH, 03301, US

(73) Assignee: ZF Friedrichshafen AG, Friedrichshafen (DE)

(21) Appl. No.: 12/052,183

(22) Filed: Mar. 20, 2008

(30) Foreign Application Priority Data
Apr. 3, 2007 (DE) 10 2007 015 995.3

(51) Int. Cl. B60R 16/02

(52) U.S. Cl. 280/727

(57) ABSTRACT

An axle module (2) for a vehicle having an electrical on-board circuit (1), an electrical on-board circuit voltage and at least one electrically driven actuator (7). The axle module has a step-up converter (10) and a control device (11) to convert the on-board circuit voltage into an axle voltage, that is higher than the on-board circuit voltage.

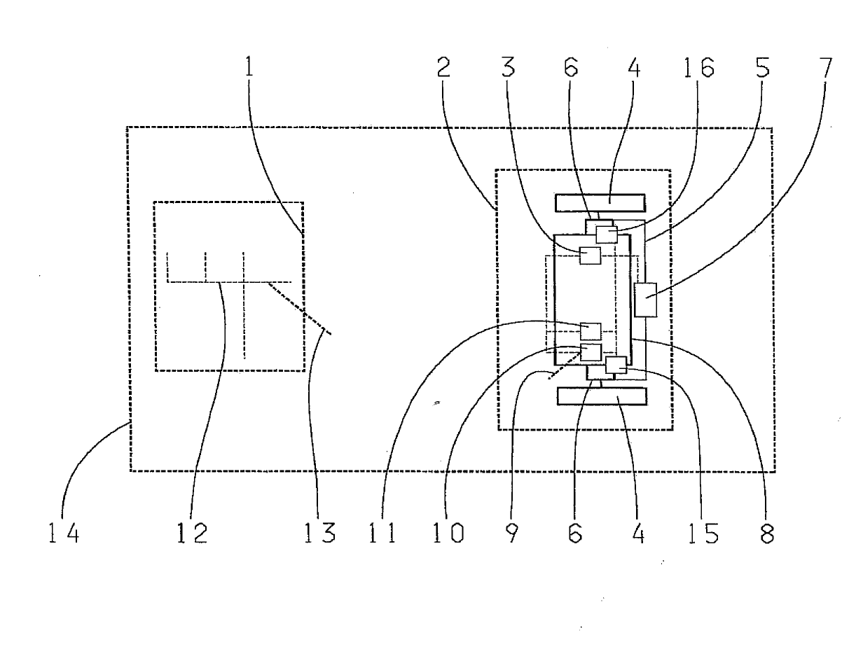

This application claims priority from German Application Serial No. 10 2007 015 995.3 filed Apr. 3, 2007.

### FIELD OF THE INVENTION

The invention pertains to an axle module for a vehicle.

### BACKGROUND OF THE INVENTION

The level of equipment for vehicles with active and semi-active suspension systems is continually increasing, while the current trend progressively leads toward replacing the hydraulic suspension systems with electro-mechanical suspension systems. This trend is promoted by the introduction of the hybrid motor, which requires a higher on-board line voltage. This favors the application of electro-mechanical suspension systems. Suspension systems are also becoming more complex, since new systems, such as active steering systems and variable damping as well as different sensors, are being added, in order to enable monitoring as well as controlling of the vehicle performance. The on-board electrical system of a vehicle is normally comprised of a power system and a communication bus, with each electrical and electronic system of the vehicle being connected to the power system and the communication bus, in order to receive power and be controlled and/or adjusted.

The increasing number of electrical and/or electronic systems contained within the vehicle is placing a greater demand on the wiring for a multitude of plug-in connections and control devices in the vehicle. The plug-in devices are not only costly but also present a quality risk.

The purpose of the invention is to reduce the number of plug-in connections between the axle module and the on-board power system in a vehicle.

### SUMMARY OF THE INVENTION

In a vehicle with an electrical on-board power circuit and a first communication bus, as well as at least one electrical actuator, which is positioned on the axle module, the invention provides for an electrical component to reduce the number of plug-in connections between the axle module and vehicle. The actuator, which is positioned on the axle module, for example, can be a part of an electro-mechanical roll compensation arrangement, a semi-active damping system, an electro-mechanical steering system, an active steering system, as well as another application.

In an advantageous solution of the axle module, the electronic component is comprised of a control device, which receives bus signals from the first communication bus and converts them to signals for the actuator that is positioned on the axle module, and/or receives signals from axle-side sensors and converts them into bus signals for the first communication bus. Due to the fact that the control device receives a bus signal, which is converted by the axle-mounted control device into several signals for the electrical actuator and/or sensor of the axle module, it is not necessary for each actuator and/or sensor of the axle module to provide an individual plug-in connection to the vehicle. This results in savings with related to costs and installation time.

In an alternative advantageous version of the axle module, the electronic component is comprised of a control device, which acts as gateway between the vehicle's first communication bus and a second communication bus, that is positioned on the axle module side, thus reducing the number of plug-in connections.

The term “axle module” refers to a group of components of the suspension system, and includes at least one wheel suspension. Additional components may vary significantly depending on the vehicle type and/or whether the an axle module is for a front or rear axle. The invention relates to all types of axle modules for vehicles, which have an on-board power system and a communication bus, regardless of whether the axle module is designed for a front or rear axle and/or whether the axle module is designed with a solid axle or an individual wheel suspension. Furthermore, it is irrelevant for the invention if the axle module is pre-installed or if the components of the axle module are individually installed on the vehicle. The core of the invention is directed at combining the electrical components of an axle module with the rest of the vehicle in a prudent and efficient manner.

A preferred embodiment of the invention illustrates a central device, which is connected to the control device is positioned at the axle module, in order to maintain the demands of the on-board circuit. The central device, to maintain the demands of the on-board circuit, is designed for all actuators and sensors of the axle module and is therefore only provided once at the axle module. Furthermore, the control device is positioned at the axle module is available for the active electronic control and/or active adjustment of the device to maintain the demands by the on-board circuit. This aids in saving space as well as costs, since not every electrical and/or electronic component must be equipped with its own device to maintain the demands by the on-board circuit. The relevant, on-board demand, for example, can consist of maintaining an upper limit of the power intake from the on-board circuit of the vehicle, as well the attenuation of voltage spikes and voltage drops.

A capacitor, super-capacitor, inductance and/or electric energy storage is proposed as a device for maintaining the demands of the on-board circuit.

The device for maintaining the demands of the on-board circuit is charged when the electrical and/or electronic components of the axle module demand no or only low power. The device for maintaining the on-board circuit demand supports the vehicle's on-board power demand when the electrical and/or electronic components demand a great amount of power. The device for maintaining the on-board circuit demands ensures an even power draw from the on-board power circuit; voltage drops in the on-board circuit are thus prevented.

In a preferred design of the axle module, the device for maintaining the on-board circuit demands is positioned in an axle support frame of the axle module.

In a variation of the invention, the axle module includes a step-up converter and/or step-down converter, to convert the voltage of the on-board power circuit, which is higher and/or lower than the voltage level of the on-board power circuit and has been adjusted to the functions of the electrical and/or electronic components of the axle module, in order to, for example, be able to keep the dimensions of the components to a minimum.

The device for maintaining the on-board circuit demands is designed at the axle module in connection with the control device. Furthermore, the number of plug-in connections remaining on the vehicle is kept to a minimum. A pre-installation of the axle module, for example performed at the supplier's location, is particularly preferred due to the few interfaces remaining on the vehicle. Ideally, only one plug-in connection for connecting the on-board circuit to the axle module will remain.

### BRIEF DESCRIPTION OF THE DRAWING

The invention will now be described, by way of example, with reference to the accompanying drawings in which:

The single FIGURE shows a schematic representation of an on-board circuit and an axle module of a motor vehicle.

### DETAILED DESCRIPTION OF THE INVENTION

The single FIGURE shows an on-board circuit 1 and an axle module 2 of a vehicle 14. The on-board circuit 1 is separated into a power circuit and a first communication bus and has a plug 13 that is installed on the vehicle, which can be combined with a plug 9 that is positioned at the axle module and therefore connects the on-board circuit 1 with the axle module 2. The axle module 2 has two wheels 4, two wheel suspensions 6, an axle support frame 8, a device for maintaining the on-board circuit demands 3, a stabilizer 5, the plug 9, a step-up converter 10, a control device 11, several electrical connections 12 and three actuators 7, 15, 16 with integrated sensors. The electrical devices 3, 7, 10, 11, 15, 16 of the axle module 2 are all connected with one another through the electrical connections 12 of the axle module 2.

The number of plug-in connections, between the on-board circuit 1 and the axle module 2, is reduced due to the control device 11. There remains only the plug-in connection, between the axle module side and vehicle side plugs 9, 13, which connect the axle module 2 with the on-board circuit 1. The control device 11 receives bus-signals of the first communication bus and converts it into signals for the actuators 7, 15, 16 and the sensors. The axle module 2 alternatively has a second communication bus and the control device 11 acts as a gateway between the first and the second communication bus.

The device for maintaining the on-board circuit demands 3 is provided on the axle module only once and is comprised of at least one capacitor and/or one super-capacitor and/or one inductance and/or one electrical energy storage device. The control device 11 is available as a device for maintaining the on-board circuit demands 3 in order to implement an electronic control and/or an active adjustment for maintaining the on-board circuit demands.

The device for maintaining the on-board circuit demands 3 is charged during the operating phases of the vehicle, where the actuator 7 uses no or only little energy. The device for maintaining the on-board circuit demands 3 also supports the on-board power circuit in situations that demand a high level of power and energy, This makes it possible to ensure an even power draw from the on-board power circuit.

The device for maintaining the on-board circuit demands 3 can be installed at the axle module 2, but it is preferably installed in voids of the axle support frame 8 of the axle module 2 in order to save space.

The step-up and/or step-down converter 10 of the axle module 2 converts the voltage of the on-board power circuit 1 into a specific axle voltage that is adjusted to the actuators 7, 15, 16 of the axle module 2. A step-down converter is particularly interesting for applications in hybrid vehicles with an electro motor and one other motor since the voltage of the on-board power circuit is much higher than the voltage necessary for the actuators 7, 15, 16.

The voltage of the on-board power circuit is converted in a step-up converter into an axle module voltage, which is higher than the voltage of the on-board power circuit. The higher local axle voltage is adjusted to the actuators 7, 15, 16, for example, to keep the dimensions of the actuators 7, 15, 16 to a minimum. When the vehicle is in motion which induces roll, the actuator 7 generates, with an active roll compensation system, a torque to the stabilizer 5 to compensate for and/or reduce the roll. The actuators 15, 16 are components of a semi-active damping system. Additional electrically driven actuators can be installed on the axle module 2 to be applied for other functions of an active suspension, for example, an active steering system.

### REFERENCE NUMERALS

1 on-board circuit (on-board power circuit and first communication bus)
2 axle module
3 device for maintaining the on-board circuit demands
4 wheel
5 stabilizer
6 wheel suspension
7 actuator
8 axle support frame
9 plug at axle module
10 step-up converter/step-down converter
11 control device
12 electrical connections
13 plug at vehicle
14 vehicle
15 actuator
16 actuator

1-9. (canceled)

10. An axle module for a vehicle having at least one electrical actuator (7) and at least one sensor being installed in the axle module (2) and the vehicle (14) has an electrical on-board circuit (1), which includes an on-board power circuit and a first communication bus, and an electrical component being installed in the axle module (2) which reduces a number of plug-in connections (9) between the axle module (2) and the electrical on-board circuit (1).

11. The axle module according to claim 10, wherein the electrical component comprises a control device (11) which at least one of receives bus-signals from the first communication bus and transforms the bus-signals into signals for the electrical actuator (7) and receives sensor signals from axle-installed sensors and transforms the signals from axle-installed sensors into the bus-signals for the first communication bus.

12. The axle module according to claim 10, wherein a second communication bus is installed in the axle module and the control device (11) is a gateway between the first communication bus and the second communication bus.

13. The axle module according to claim 10, wherein a single device is installed on the axle module for maintaining on-board circuit demands (3).

14. The axle module according to claim 13, wherein the device for maintaining the on-board circuit demands (3) comprises at least one of a capacitor, a super-capacitor, an inductor and an electrical energy storage device.

15. The axle module according to claim 13, wherein the device for maintaining the on-board circuit demands (3) is positioned inside an axle support frame (8).

16. The axle module according to claim 10, further comprising a control device (11) for at least one of active electronic control and active adjustment to maintain on-board power demands.

17. The axle module according to claim 10, wherein one of a step-up converter and a step-down converter (10) is installed in the axle module (2) for converting an on-board circuit voltage into an axle voltage.

18. The axle module according to claim 17, wherein the one of the step-up converter and the step-down converter (10) is integrated in the control device (10) which is positioned at the axle.

19. A axle module for simplifying coupling to an electrical system of a vehicle including a power circuit and a first communication bus, the axle module being located on an axle of the vehicle and comprising;
a plurality of actuators and sensors for controlling at least one assembly of a suspension system of the vehicle;
a second communication bus connected to the plurality of actuators and sensors for transmitting actuation signals to the actuators and receiving sensor signals from the sensors;
a control device being connected to the first communication bus and the second communication bus for collecting, converting and sending the activation signals and the sensor signals between the electrical system and the axle module;
an electrical unit for supporting the electrical system by supplying at least a portion of electrical energy to axle module;
at least one of a step-up converter and a step-down converter for converting the electrical energy passed between the electrical system and the axle module; and
a plug-in connector for coupling the axle module with the electrical system.
